(19) United States
(12) Patent Application Publication
(10) Pub. No.: US 2014/0323089 A1
(43) Pub. Date: Oct. 30, 2014

(54) POWER-OFF PROTECTION METHOD AND AN APPARATUS THEREFOR

(71) Applicant: SAMSUNG ELECTRONICS CO., LTD., Suwon-si (KR)

(72) Inventors: Jinteng TANG, Hangzhou (CN); Xiangrong YANG, Hangzhou (CN)

(73) Assignee: SAMSUNG ELECTRONICS CO., LTD., Suwon-si (KR)

(21) Appl. No.: 14/251,846

(22) Filed: Apr. 14, 2014

(30) Foreign Application Priority Data
Apr. 27, 2013 (CN) 201310151559.X
Nov. 4, 2013 (KR) 10-2013-0132994

(51) Int. Cl. H04W 12/06

(52) U.S. Cl. CPC H04W 12/06
USPC 455/411

(57) ABSTRACT

Provided are a power-off protection method and apparatus for providing a security function to a mobile terminal. The power-off protection method includes: starting an authority inspection program that is previously set in a mobile terminal when a power-off request is received from a user; performing an authority inspection for a user input through an authority inspection program in order to determine whether to perform a power-off operation of the mobile terminal; and executing the power-off operation of the mobile terminal if it is determined that the user passes the authority inspection.

### CROSS-REFERENCE TO RELATED APPLICATION

This application claims priority from Korean Patent Application No. 10-2013-0132994, filed on Nov. 4, 2013, and Chinese Patent Application No. 201310151559.X, filed on Apr. 27, 2013, in the Korean Intellectual Property Office, the disclosure of which is incorporated herein in its entirety by reference.

### BACKGROUND

The inventive concept relates to a power-off protection method and an apparatus therefor, and more particularly, to a power-off protection method for performing a security function for a mobile terminal and a mobile device, and an apparatus therefor.

Mobile terminals such as mobile phones, portable computers, and personal digital devices have become widely used in people's lives with the development in electrical technology.

Currently, manufacturers and users of the mobile terminals have interest in power-on protection, for example, a protection method for requesting a password input when a mobile terminal is turned on, but the manufacturers and the users ignore protection of rights when the mobile terminal is turned off. Therefore, it is possible someone may turn off the mobile terminal against intentions of the owner of the mobile terminal. For example, when a mobile terminal is stolen by someone, this person may turn off the mobile terminal in order to prevent the mobile terminal from being located by the owner of the mobile terminal through calls or a search of a global positioning system (GPS) location. Although most mobile terminals have a lock function, and/or batteries of some mobile terminals cannot be removed, someone may still turn off the mobile terminals when the users unlock the mobile terminals. Accordingly, serious potential security problems exist when the mobile terminals are turned off.

### SUMMARY

One or more exemplary embodiments provide a method of preventing a mobile terminal from being turned off by a user who has no authority to use the mobile terminal in order to improve security of the mobile terminal.

One or more exemplary embodiments also provide an apparatus for preventing a mobile terminal from being turned off by a user who has no authority to use the mobile terminal in order to improve security of the mobile terminal.

According to an aspect of an exemplary embodiment, there is provided a power-off protection method, the method including: starting an authority inspection program that is previously set in a mobile terminal when a power-off request is received from a user; performing an authority inspection for a user input through an authority inspection program in order to determine whether to perform a power-off operation of the mobile terminal; and executing the power-off operation of the mobile terminal if it is determined that the user passes the authority inspection.

The method may further include not performing the power-off operation of the mobile terminal to maintain the mobile terminal in a power-on state if the user input fails to pass the authority inspection.

The authority inspection program may be installed in the mobile terminal by the user or a manufacturer of the mobile terminal.

The user input may include at least one of a password input, a fingerprint input, a facial image input, and a voice input.

The authority inspection program may perform at least one of password recognition, fingerprint recognition, face recognition, and voice recognition in order to perform the authority inspection for the user input.

According to an aspect of another exemplary embodiment, there is provided a power-off protection apparatus including: a start module configured to start an authority inspection program that is previously set in a mobile terminal when a power-off request is received from a user; an inspection module configured to perform an authority inspection for a user input through the authority inspection program in order to determine whether to perform a power-off operation of the mobile terminal; and an execution module configured to execute the power-off operation of the mobile terminal if the user input passes the authority inspection.

The execution module may ignore perform the power-off operation to maintain a power-on state if the user input fails to pass the authority inspection.

According to an aspect of yet another exemplary embodiment, there is provided a mobile terminal including: an input unit configured to generate an input signal to operate the mobile terminal; a memory configured to store an authority inspection program; and a control unit configured to perform an authority inspection for a user input by executing the authority inspection program stored in the memory when a power-off input signal is received from the input unit, and block a power-off operation if the user input fails to pass the authority inspection.

The control unit may execute the power-off operation if the user input passes the authority inspection, and block the power-off operation if the user input fails to pass the authority inspection.

The user input may include at least one of a password input, a fingerprint input, a facial image input, and a voice input.

The mobile terminal may further include a battery locking unit configured to prevent removal of a battery from the mobile terminal, and the battery locking unit may unlock a battery locking state if the user input passes the authority inspection.

The battery locking unit may maintain the battery locking state if the user input fails to pass the authority inspection.

The mobile terminal may further include a main power supply unit; and a backup power supply unit. The power according to the backup power supply unit may be supplied to the mobile terminal if power supply according to the main power supply unit is blocked.

The main power supply unit may include a battery.

The backup power supply unit may be installed in the mobile terminal.

### BRIEF DESCRIPTION OF THE DRAWINGS

Exemplary embodiments of the inventive concept will be more clearly understood from the following detailed description taken in conjunction with the accompanying drawings, in which:

FIG. 1 is a flowchart of a power-off protection method according to an exemplary embodiment of the inventive concept;

FIG. 2 is a block diagram of a power-off protection apparatus according to an exemplary embodiment of the inventive concept;

FIG. 3A is a diagram illustrating main components of a mobile terminal according to an exemplary embodiment of the inventive concept;

FIG. 3B is a diagram illustrating main components of a mobile terminal according to another exemplary embodiment of the inventive concept;

FIG. 4A illustrates an entire structure of a mobile terminal according to an exemplary embodiment of the inventive concept;

FIG. 4B illustrates an entire structure of a mobile terminal according to another exemplary embodiment of the inventive concept;

FIG. 5 illustrates a detailed structure of a power supply unit illustrated in FIG. 4A or 4B, according to an exemplary embodiment of the inventive concept;

FIG. 6 is a schematic diagram of a battery locking medium in a mobile terminal, according to an exemplary embodiment of the inventive concept;

FIG. 7 is a detailed flowchart of a power-off protection method in a mobile terminal, according to an exemplary embodiment of the inventive concept; and

FIG. 8 is a detailed flowchart of a power-off protection method in a mobile terminal, according to another exemplary embodiment of the inventive concept.

### DETAILED DESCRIPTION OF THE EXEMPLARY EMBODIMENTS

The inventive concept now will be described more fully hereinafter with reference to the accompanying drawings, in which illustrative exemplary embodiments are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout. In the drawings, the sizes and the thicknesses of layers and regions are exaggerated for convenience of explanation, and thus the sizes and the thicknesses are not limited thereto. Expressions such as “at least one of,” when preceding a list of elements, modify the entire list of elements and do not modify the individual elements of the list.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

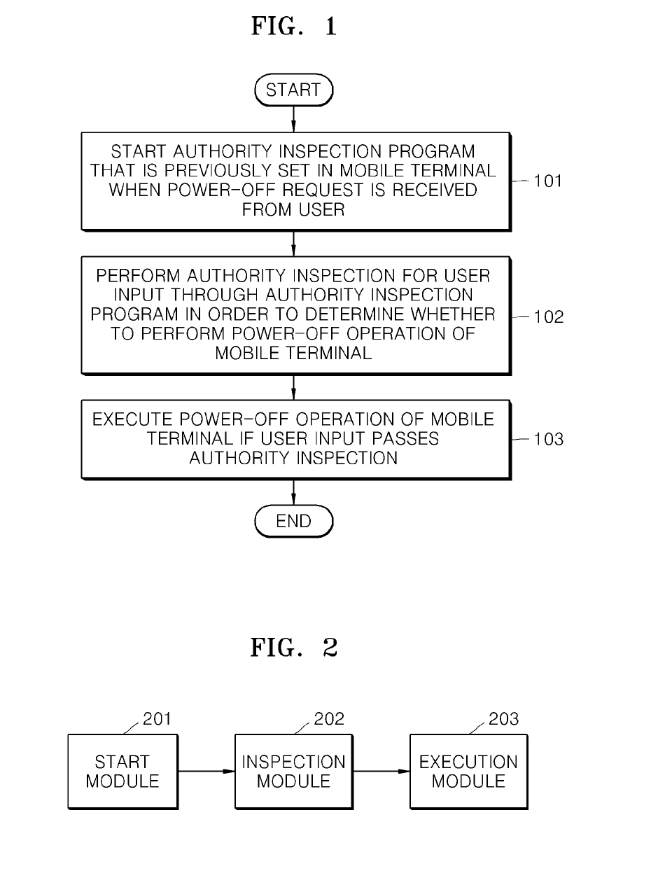

FIG. 1 is a flowchart of a power-off protection method according to an exemplary embodiment of the inventive concept.

Referring to FIG. 1, in operation 101, an authority inspection program that is previously set in a mobile terminal starts when a power-off request from a user is received. According to the present embodiment, the authority inspection program may be installed in the mobile terminal by a manufacturer of the mobile terminal or by the user of the mobile terminal after the user purchases the authority inspection program. However, the inventive concept is not limited thereto, and the authority inspection program may be installed in the mobile terminal through other ways.

In operation 102, an authority inspection is performed by a user input through the authority inspection program that determines whether to perform a power-off operation of the mobile terminal. Examples of the user input may be a password input, a fingerprint input, a facial image input, a voice input, or the like. However, the user input is not limited only to the foregoing inputs. Accordingly, the authority inspection program performs at least one operation of password recognition, fingerprint recognition, face recognition, voice recognition, and the like in order to determine whether the user input passes the authority inspection.

In operation 103, if the user input passes the authority inspection, the power-off operation of the mobile terminal is performed. That is, a user who has authority over the mobile terminal may turn off the mobile terminal. On the contrary, if the user input fails to pass the authority inspection, the power-off operation is terminated to maintain the mobile terminal in a power-on state. Here, the failure to pass the authority inspection may include a case in which the authority inspection is not performed so that an unintended power-off state can be prevented.

FIG. 2 is a block diagram of a power-off protection apparatus according to an exemplary embodiment of the inventive concept.

Referring to FIG. 2, the power-off protection apparatus includes a start module 201, an inspection module 202, and an execution module 203.

When the power-off request from the user is received, the start module 201 starts the authority inspection program that is previously set in the mobile terminal. The inspection module 202 performs the authority inspection for the user input through the authority inspection program in order to determine whether to perform the power-off operation of the mobile terminal. The execution module 203 performs the power-off operation of the mobile terminal if the user input passes the authority inspection.

Therefore, by applying the power-off protection method and apparatus according to the above embodiments of the inventive concept, a user who is authenticated as an owner of the mobile terminal may turn off the mobile terminal so as to improve security thereof.

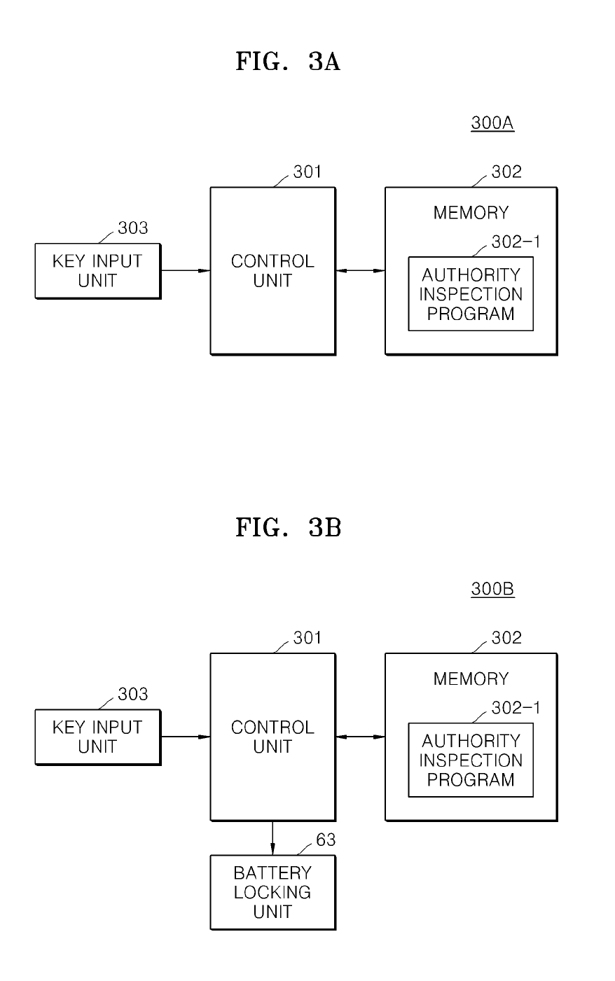

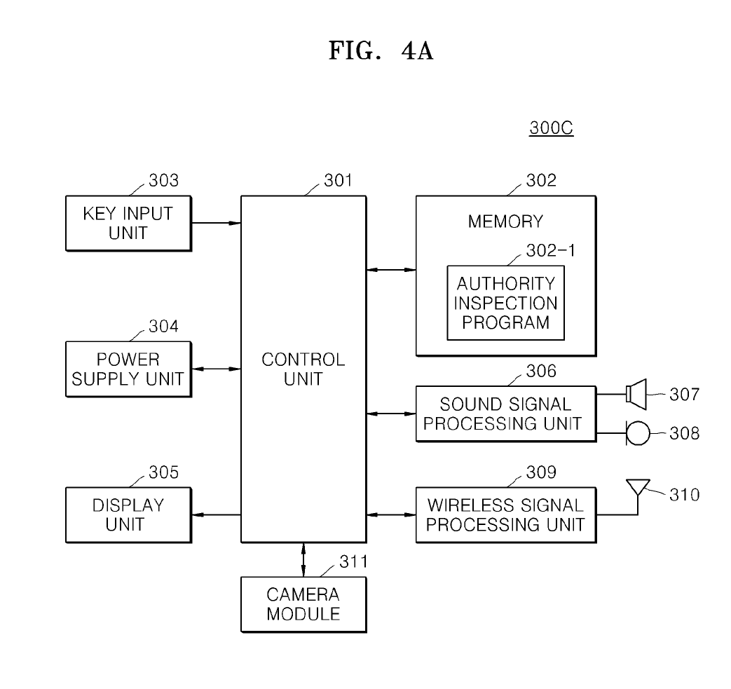

FIG. 3A is a diagram illustrating main components of a mobile terminal 300A according to an exemplary embodiment of the inventive concept.

Referring to FIG. 3A, the mobile terminal 300A includes a control unit 301, a memory 302, and a key input unit 303.

The memory 302 may include a non-volatile memory or a volatile memory. For example, the non-volatile memory may be the non-volatile memory such as a flash memory device, phase change random access memory (PRAM), ferroelectric RAM (FRAM), or magnetic RAM (MRAM). As another example, the memory 302 may be the volatile memory such as dynamic RAM (DRAM) or static RAM (SRAM). Alternatively, the memory 302 may be one or more volatile memories, and one or more non-volatile memories.

An authority inspection program 302-1 is stored in the memory 302. The authority inspection program 302-1 may be stored in the memory 302 by a manufacturer of the mobile terminal 300A. Also, the authority inspection program 302-1 may be stored in the memory 302 by a user through a memory interface. User authentication information is also stored in the memory 302. For example, the user authentication information may include password information, fingerprint pattern information, facial pattern information, voice pattern information, etc.

The key input unit 303, in which keys necessary to operate the mobile terminal 300A are arranged, generates key signals corresponding to inputs of the arranged keys. For example, various functional keys such as a power-on key, and a power-off key, and numeric keys may be arranged in the key input unit 303 to receive corresponding inputs. In addition, the key input unit 303 generates key signals corresponding to keys input by the user. However, the key input unit 303 is not limited to only keys, and may be implemented by various different structures. For example, the key input unit 303 may include a voice input recognition unit.

The control unit 301 performs operations for generally controlling the mobile terminal 300A. In particular, the control unit 301 performs control operations corresponding to key signals received from the key input unit 303.

The control unit 301 reads the authority inspection program 302-1 from the memory 302 when a power-off key signal is received, and performs an authority inspection operation. The authority inspection operation requires a user input necessary for the user authentication, and if the user input received according to a user input request is consistent with the user authentication information stored in the memory 302, it may be determined that the user input has passed the authority inspection. In a case where the user input received according to the user input request is inconsistent with the user authentication information stored in the memory 302, it may be determined that the user input has failed to pass the authority inspection. For example, the user input may include at least one of the password input, the fingerprint input, the facial image input, the voice input, etc., not being limited thereto.

The control unit 301 blocks the power-off operation if the user input fails to pass the authority inspection. That is, if the user input fails to pass the authority inspection, the control unit 301 maintains the power-on state by ignoring the power-off request according to the power-off key signal received from the key input unit 303.

The control unit 301 performs the power-off operation if the user input passes the authority inspection. That is, if the user input passes the authority inspection, the control unit 301 accepts the power-off request according to the power-off key signal received from the key input unit 303, and performs the power-off operation. The control unit 301 may be or correspond to the power-off protection apparatus illustrated in FIG. 2.

FIG. 3B is a diagram illustrating main components of a mobile terminal 300B according to another exemplary embodiment of the inventive concept.

Referring to FIG. 3B, the mobile terminal 300B includes a control unit 301, a memory 302, a key input unit 303, and a battery locking unit 63.

Operations with regard to the control unit 301, the memory 302, and the key input unit 303 are already described with reference to FIG. 3A, thereby omitting the repeated descriptions.

The mobile terminal 300B further includes the battery locking unit 63 in comparison with the mobile terminal 300A of FIG. 3A.

In addition, the control unit 301 generates control signals for unlocking a battery locking state if the user input passes the authority inspection. The battery locking unit 63 unlocks the battery locking state when the control signals for unlocking the battery locking state are received. When the control signals for unlocking the battery locking state are not received, the battery locking unit 63 maintains the battery locking state. The battery locking unit 63 will be further described later with reference to FIG. 6.

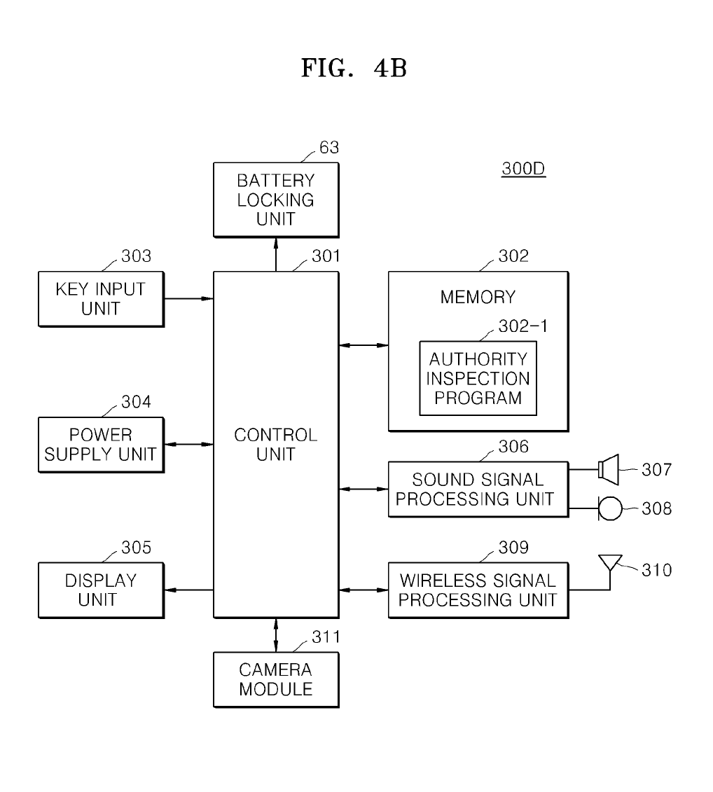

FIG. 4A illustrates an entire structure of a mobile terminal 300C according to an exemplary embodiment of the inventive concept.

Referring to FIG. 4A, the mobile terminal 300C includes a control unit 301, a memory 302, a key input unit 303, a power supply unit 304, a display unit 305, a voice signal processing unit 306, a speaker 307, a microphone 308, a wireless signal processing unit 309, an antenna 310, and a camera module 311.

The memory 302 and the key input unit 303 are already described with reference to FIG. 3A, and thus, repeated descriptions thereof are omitted.

The power supply unit 304 is a way to supply power necessary to operate the mobile terminal 300C. For example, the power supply unit 304 may supply power by using a battery. Also, the power supply unit 304 includes a circuit structure for supplying main power and back-up power, and may be designed to supply the back-up power to the mobile terminal 300C when the main power is blocked.

The display unit 305 displays image data output from the control unit 301. For example, the display unit 305 may be configured as a liquid crystal display.

The voice signal processing unit 306 may decode electrical voice signals received from the microphone 308 in order to output the decoded electrical voice signals to the control unit 301, or may decode signals received from the control unit 301 and convert the decoded signals into electrical voice signals in order to output the converted electrical voice signals to the speaker 307.

The wireless signal processing unit 309 processes signals for receiving/transmitting data from/to a wireless channel through the antenna 310.

The antenna 310 transmits or receives electric waves in order to transmit/receive signals in a wireless manner.

The camera module 311 generates image signals by capturing a moving image of an object, and outputs the generated image signals to the control unit 301.

The control unit 301 performs operations for generally controlling the mobile terminal 300C. In particular, the control unit 301 performs control operations corresponding to the key signals received from the key input unit 303.

The control unit 301 may perform the authority inspection operations by reading the authority inspection program stored in the memory 302 when the power-off key signals are received from the key input unit 303.

For example, the control unit 301 generates image or video data that requires the user input necessary for the user authentication according to the authority inspection program, and outputs the generated image or video data to the display unit 305. Accordingly, a guide screen that requires the user input necessary for the user authentication may be output on the display unit 305.

As another example, the control unit 301 generates voice data that requires the user input necessary for the user authentication according to the authority inspection program, and outputs the generated voice data to the voice signal processing unit 306. Accordingly, a guide voice signal that requires the user input through the voice signal processing unit 306 may be output to the speaker 307.

According to the guide screen or guide voice signal for the authority inspection, the user may input the user input necessary for the user authentication to the mobile terminal 300C.

For example, the user input necessary for the user authentication may be performed by inputting passwords through the key input unit 303. As another example, the user input necessary for the user authentication may be performed by inputting fingerprints through the camera module 311. Alternatively, the user input necessary for the user authentication may be performed by inputting a facial image through the camera module 311. As another example, the user input necessary for the user authentication may be performed by inputting a voice through the microphone 308.

When the user input is received by the control unit 301 according to the user input request necessary for the user authentication, the control unit 301 performs the authority inspection by comparing the received user input with the authentication information stored in the memory 302.

For example, when a password is received as the user input through the key input unit 303, the control unit 301 compares the received password with password information stored in the memory 302. As another example, when the fingerprint input is received as the user input, the control unit 301 compares the received fingerprint input with fingerprint pattern information stored in the memory 302. Alternatively, when the facial image input is received as the user input, the control unit 301 compares the received facial image input with facial pattern information stored in the memory 302. Alternatively, when the voice input is received as the user input, the control unit 301 compares the received voice input with voice pattern information stored in the memory 302.

For example, if the password that is the user input is consistent with the password information stored in the memory 302, the control unit 301 may determine that the user input passes the authority inspection.

As another example, when the authority inspection according to the fingerprint recognition, the face recognition, and/or the voice recognition is performed, the control unit 301 compares characteristic patterns extracted from the fingerprint input, the facial image input, and/or the voice input with information on fingerprint patterns, facial patterns, and/or voice patterns stored in the memory 302, and analyzes the comparison. If consistency exceeds a critical value as a result of a comparison analysis, the control unit 301 may determine that the user input passes the authority inspection.

If the user input fails to pass the authority inspection, the control unit 301 does not perform the received power-off request. That is, if the user input fails to pass the authority inspection, the control unit 301 ignores the power-off request according to the power-off key signal received from the key input unit 303, and maintains the power-on state.

If the user input passes the authority inspection, the control unit 301 performs the power-off operation. That is, if the user input passes the authority inspection, the control unit 301 accepts the power-off request according to the power-off key signal received from the key input unit 303, and performs the power-off operation.

FIG. 4B illustrates an entire structure of a mobile terminal 300D according to another exemplary embodiment of the inventive concept.

Referring to FIG. 4B, the mobile terminal 300D includes a control unit 301, a memory 302, a key input unit 303, a power supply unit 304, a display unit 305, a voice signal processing unit 306, a speaker 307, a microphone 308, a wireless signal processing unit 309, an antenna 310, a camera module 311, and a battery locking unit 63.

Operations of the control unit 301, the memory 302, the key input unit 303, the power supply unit 304, the display unit 305, the voice signal processing unit 306, the speaker 307, the microphone 308, the wireless signal processing unit 309, the antenna 310, the camera module 311 are already described with reference to FIG. 4A, and thus, repeated descriptions thereof are omitted.

The mobile terminal 300D further includes the battery locking unit 63 in comparison with the mobile terminal 300C of FIG. 4A.

In addition, if the user input passes the authority inspection, the control unit 301 generates control signals for unlocking a battery locking state. When the control signals for unlocking the battery locking state are received, the battery locking unit 63 performs an operation of unlocking the battery locking state. When the control signals for unlocking the battery locking state are not received, the battery locking unit 63 maintains the battery locking state.

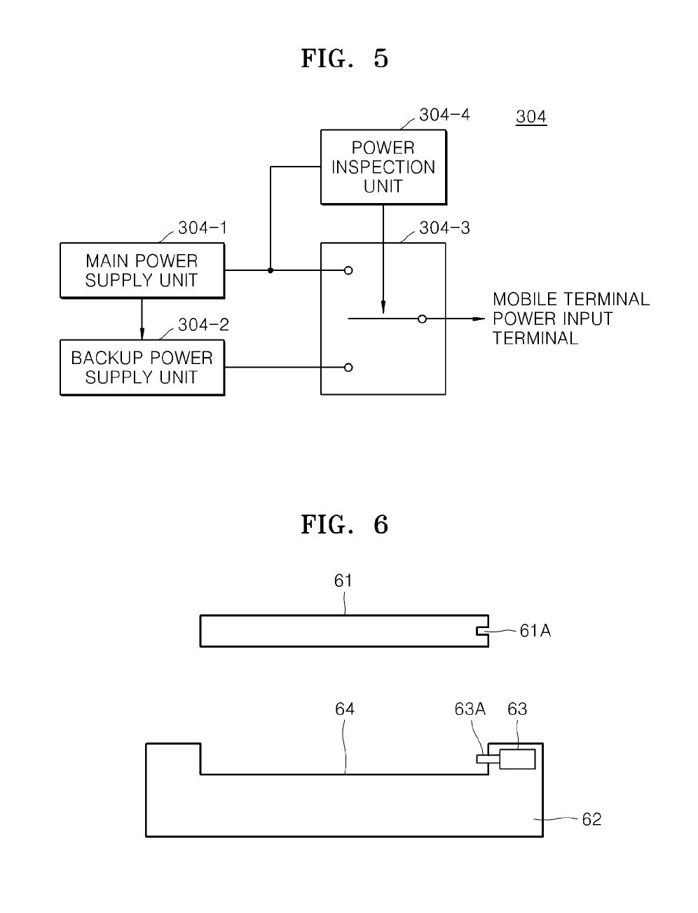

FIG. 5 details a structure of the power supply unit 304 illustrated in FIG. 4A or 4B, according to an exemplary embodiment of the inventive concept.

Referring to FIG. 5, the power supply unit 304 includes a main power supply unit 304-1, a backup power supply unit 304-2, a switching unit 304-3, and a power inspection unit 304-4.

The main power supply unit 304-1 supplies main power required in a mobile terminal described above in any of FIGS. 3A to 4B. For example, the main power supply unit 304-1 may be configured as an external battery.

The backup power supply unit 304-2 generates backup power by charging power output from the main power supply unit 304-1. For example, the backup power supply unit 304-2 may be configured as a charging circuit using a capacitor or a built-in battery.

The power inspection unit 304-4 determines whether the main power output from the main power supply unit 304-1 is blocked, and if it is determined that the main power is not blocked, the power inspection unit 304-4 generates a first switching control signal for outputting the main power to a power input terminal of the mobile terminal. Otherwise, if it is determined that the main power is blocked, the power inspection unit 304-4 generates a second switching control signal for outputting the backup power to the power input terminal of the mobile terminal. For example, when voltage of the main power is lower than a critical voltage, it may be determined that the main power is blocked.

The switching unit 304-3 selects one of the main power and the backup power according to the first or second switching control signal generated in the power inspection unit 304-4, and outputs the selected switching control signal to the power input terminal of the mobile terminal 300B.

Although an external battery, which is the main power of the mobile terminal, is removed from the main body by the user who has no authority over the mobile terminal due to the above-described operations, the power-on state may be maintained for more than a certain amount of time by the backup power.

FIG. 6 is a schematic diagram of the battery locking unit 63 in a mobile terminal, according to an exemplary embodiment of the inventive concept. The mobile terminal mentioned here may be any mobile terminal shown in FIGS. 3A to 4B

Referring to FIG. 6, a battery 61 has a structure that a groove 61A is formed in a side thereof. The battery locking unit 63 is installed on a side of a surface 64 of a main body 62 of the mobile terminal in which the battery 61 is mounted.

The battery locking unit 63 includes a protrusion member 63A that moves according to a result of the authority inspection. If the user input passes the authority inspection, the battery locking unit 63 moves the protrusion member 63A to an unlocking state. If the user input fails to pass the authority inspection, the battery locking unit 63 maintains a locking state of the protrusion member 63A.

When the battery 61 is mounted in the surface 64 of the main body 62 of the mobile terminal, the battery locking unit 63 moves the protrusion member 63A to insert the protrusion member 63A into the groove 61A in the side of the battery 61. For example, the battery locking unit 63 may move the protrusion member 63A by using a latch and/or a motor (not shown). When the protrusion member 63A is inserted into the groove 61A in the side of the battery 61, removal of the battery 61 from the main body 62 of the mobile terminal may be prevented. Accordingly, the mobile terminal may be in a battery locking state.

If the user input passes the authority inspection based on the authority inspection program according to the power-off request, the battery locking unit 63 moves the protrusion member 63A to unlock the battery locking state. For example, when the control signals for unlocking the battery locking state are received, the battery locking unit 63 moves the protrusion member 63A to unlock the battery locking state.

If the user input fails to pass the authority inspection based on the authority inspection program according to the power-off request, the battery locking state is maintained. That is, the removal of the battery 61 from the main body 62 of the mobile terminal may be prevented.

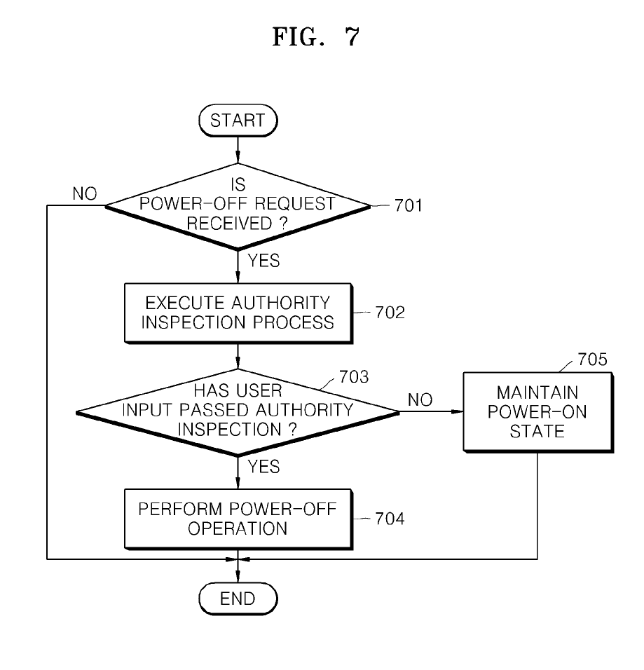

The power-off protection method performed in the mobile terminal 300A or 300C of FIG. 3A or FIG. 4A will be described with reference to a flowchart of FIG. 7.

FIG. 7 is a flowchart of a power-off protection method in a mobile terminal, according to an exemplary embodiment of the inventive concept.

In operation 701, the mobile terminal determines whether a power-off request is received. For example, when a power-off key installed in the key input unit 303 is input, the power-off request is made. When the power-off key is input, the key input unit 303 transmits a power-off key signal to the control unit 301. When the power-off key signal is received, the control unit 301 may determine that the power-off request is received.

In operation 702, when the power-off request is received, the mobile terminal may execute an authority inspection process. When the power-off key signal is received, the control unit 301 executes the authority inspection process by executing the authority inspection program stored in the memory 302. For example, the authority inspection process requires the user input necessary for the user authentication, the control unit 301 compares the user input received according to the user input with the user authentication information stored in the memory 302, and analyzes a comparison result.

In operation 703, the mobile terminal determines whether the user input passes the authority inspection according to execution of the authority inspection process. For example, if a password, which is the user input, is consistent with password information stored in the memory 302, the control unit 301 may determine that the user input has passed the authority inspection. As another example, when the authority inspection according to the fingerprint recognition, the face recognition, and/or the voice recognition is performed, the control unit 301 compares the characteristic patterns extracted from the fingerprint input, the facial image input, and/or the voice input with the information on fingerprint patterns, facial patterns, and/or voice patterns stored in the memory 302, and analyzes the comparison. If consistency exceeds a critical value as a result of a comparison analysis, the control unit 301 may determine that the user input has passed the authority inspection.

In operation 704, if the user input passes the authority inspection, the mobile terminal performs the power-off operation. For example, if the user input passes the authority inspection, the control unit 301 performs the power-off operation by accepting the power-off request according to the power-off key received from the key input unit 303.

In operation 705, if the user input fails to pass the authority inspection fails, the mobile terminal maintains the power-on state. For example, if the user input fails to pass the authority inspection, the control unit 301 ignores the power-off request according to the power-off key received from the key input unit 303, and maintains the power-on state.

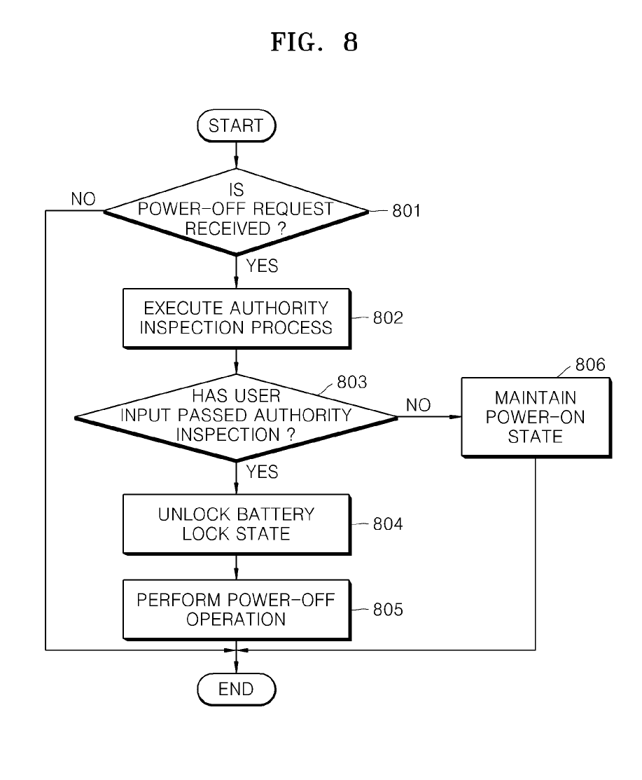

The power-off protection method performed in the mobile terminal 300B or 300D of FIG. 3B or FIG. 4B will be described in a time-series method with reference to a flowchart of FIG. 8.

FIG. 8 is a detailed flowchart of a power-off protection method in a mobile terminal, according to another exemplary embodiment of the inventive concept.

In operation 801, the mobile terminal determines whether the power-off request is received. For example, when the power-off key installed in the key input unit 303 is input, the power-off request is made. When the power-off key is input in the key input unit 303, the power-off key signal is transmitted to the control unit 301. The control unit 301 may determine that the power-off request is received when the power-off key signal is received.

In operation 802, when the power-off request is received, the mobile terminal executes the authority inspection process. For example, when power-off key signal is received, the control unit 301 executes the authority inspection process by executing the authority inspection program stored in the memory 302. For example, the authority inspection process requires the user input necessary for the user authentication. When the user input is received according to the user input request, the user input and the user authentication information stored in the memory 302 may be compared and analyzed.

In operation 803, the mobile terminal determines whether the user input passes the authority inspection according to the execution of the authority inspection process. For example, if a password, which is the user input, is consistent with the password information stored in the memory 302, the control unit 301 may determine that the user input has passed the authority inspection. As another example, when the authority inspection according to the fingerprint recognition, the face recognition, and/or the voice recognition is performed, the control unit 301 compares the characteristic patterns extracted from the fingerprint input, the facial image input, and/or the voice input with the information on fingerprint patterns, facial patterns, and/or voice patterns stored in the memory 302, and analyzes the comparison. If consistency exceeds a critical value as a result of the comparison analysis, the control unit 301 may determine that the user input has passed the authority inspection.

In operation 804, if the user input passes the authority inspection, the mobile terminal unlocks the battery locking state. For example, if the user input passes the authority inspection, the control unit 301 outputs the control signals for unlocking the battery locking state to the battery locking unit 63. According to the control signals for unlocking the battery locking state, the battery locking unit 63 performs an operation of unlocking the battery locking state.

In operation 805, if the user input passes the authority inspection, the mobile terminal performs the power-off operation. For example, if the user input passes the authority inspection, the control unit 301 accepts the power-off request according to the power-off key received from the key input unit 303, and performs the power-off operation.

In operation 806, if the user input fails to pass the authority inspection, the mobile terminal maintains the power-on state and the battery locking state. For example, if the user input fails to pass the authority inspection, the control unit 301 ignores the power-off request according to the power-off key received from the key input unit 303, and maintains the power-on state. Also, if the user input fails to pass the authority inspection, the control unit 301 blocks generation of the control signals for unlocking the battery locking state in order to maintain the battery locking state.

The various modules and units illustrated in FIGS. 2-5 may be embodied as the various numbers of hardware, software and/or firmware structures that execute respective functions described above, according to exemplary embodiments of the inventive concept. For example, these modules and units may use a direct circuit structure, such as a memory, processing, logic, a look-up table, etc. that may execute the respective functions through controls of one or more microprocessors or other control apparatuses.

While the inventive concept has been particularly shown and described with reference to exemplary embodiments thereof, it will be understood that various changes in form and details may be made therein without departing from the spirit and scope of the following claims.

What is claimed is:

1. A power-off protection method, the method comprising:
starting an authority inspection program that is previously set in a mobile terminal when a power-off request is received from a user;
performing an authority inspection for a user input through an authority inspection program in order to determine whether to perform a power-off operation of the mobile terminal; and
executing the power-off operation of the mobile terminal if the user input passes the authority inspection.

2. The power-off protection method of claim 1, further comprising:
not performing the power-off operation of the mobile terminal to maintain the mobile terminal in a power-on state if the user input fails to pass the authority inspection.

3. The power-off protection method of claim 1, wherein the authority inspection program is installed in the mobile terminal by the user or a manufacturer of the mobile terminal.

4. The power-off protection method of claim 1, wherein the user input comprises at least one of a password input, a fingerprint input, a facial image input, and a voice input.

5. The power-off protection method of claim 4, wherein the authority inspection program performs at least one of password recognition, fingerprint recognition, face recognition, and voice recognition in order to perform the authority inspection for the user input.

6. The power-off protection method of claim 1, wherein the power-off operation is not performed in the mobile terminal if the authority inspection program is not started.

7. The power-off protection method of claim 1, further comprising:
requesting the user input when the power-off request is received from the user; and
determining whether the user input exceeds a predetermined threshold to determine whether the user input passes the authority inspection.

8. A power-off protection apparatus comprising:
a start module configured to start an authority inspection program that is previously set in a mobile terminal when a power-off request is received from a user;
an inspection module configured to perform an authority inspection for a user input through the authority inspection program in order to determine whether to perform a power-off operation of the mobile terminal; and
an execution module configured to execute the power-off operation of the mobile terminal if the user input passes the authority inspection.

9. The power-off apparatus of claim 8, wherein the execution module is configured not to perform the power-off operation to maintain a power-on state if the user input fails to pass the authority inspection.

10. The power-off apparatus of claim 8, wherein the execution module is configured not to perform the power-off operation in the mobile terminal if the authority inspection program is not started.

11. The power-off apparatus of claim 8, wherein the inspection module is further configured to request the user input when the power-off request is received from the user, and
wherein the execution module is further configured to determine whether the user input exceeds a predetermined threshold to determine whether the user input passes the authority inspection.

12. A mobile terminal comprising:
an input unit configured to generate an input signal to operate the mobile terminal;
a memory configured to store an authority inspection program; and
a control unit configured to perform an authority inspection for a user input by executing the authority inspection program stored in the memory when a power-off input signal is received from the input unit, and block a power-off operation if the user input fails to pass the authority inspection.

13. The mobile terminal of claim 12, wherein the control unit is configured to execute the power-off operation if the user input passes the authority inspection, and block the power-off operation if the user input fails to pass the authority inspection.

14. The mobile terminal of claim 12, wherein the user input comprises at least one of a password input, a fingerprint input, a facial image input, and a voice input.

15. The mobile terminal of claim 12, wherein the mobile terminal further comprises a battery locking unit configured to prevent removal of a battery from the mobile terminal, and
wherein the battery locking unit is configured to unlock a battery locking state if the user input passes the authority inspection.

16. The mobile terminal of claim 15, wherein the battery locking unit maintains the battery locking state if the user input fails to pass the authority inspection.

17. The mobile terminal of claim 12, further comprising:
a main power supply unit; and
a backup power supply unit,
wherein power according to the backup power supply unit is supplied to the mobile terminal if power supply according to the main power supply unit is blocked.

18. The mobile terminal of claim 17, wherein the backup power supply unit is configured to supply power to the mobile terminal unless the user input passes the authority inspection, even when the main power supply unit is removed from the mobile terminal.

19. The mobile terminal of claim 12, wherein the control unit is configured not to perform the power-off operation if the authority inspection program is not executed.

20. The mobile terminal of claim 12, wherein the control unit is further configured to request the user input when the power-off input signal is received from the input unit, and
wherein the control unit is further configured to determine whether the user input exceeds a predetermined threshold to determine whether the user input passes the authority inspection, and execute the power-off operation if it is determined that the user input exceeds the predetermined threshold.
